(19) United States
(12) Patent Application Publication
(10) Pub. No.: US 2002/0010090 A1
(43) Pub. Date: Jan. 24, 2002

(54) Oxidizing catalysts, carbon monoxide sensor, and hydrogen sensor

(76) Inventor: Yoshio Ono, Kitakatsushika-gun (JP)

Correspondence Address: FLYNN, THIEL, BOUTELL & TANIS, P.C., 2026 Rambling Road, Kalamazoo, MI, 49008-1699, US

(21) Appl. No.: 09/910,390

(22) Filed: Jul. 20, 2001

(30) Foreign Application Priority Data
Nov. 16, 1999 (JP) 11-325202

(51) Int. Cl. B01J 23/26

(52) U.S. Cl. 502/313; 502/324; 423/247

(57) ABSTRACT

The present invention provides a catalyst selectively oxidizing carbon monoxide in a mixed gas comprising carbon monoxide and hydrogen as well as a catalyst selectively oxidizing hydrogen. A catalyst selectively oxidizing carbon monoxide is obtained by dispersing platinum black on a surface of a base metal compound oxide including Co₂O₃, MnO₂, CuO, and Cr₂O₃, and forming an Ag₂O layer on the platinum black layer. The catalyst selectively oxidizing hydrogen in a mixed gas comprising carbon monoxide and hydrogen is obtained by dispersing Ag₂O on a surface of said base metal compound oxide and further forming a platinum black layer on the Ag₂O layer. In addition the present invention provides a contact combustion carbon monoxide sensor not having the sensitivity to hydrogen as well as that not having the sensitivity to carbon monoxide.

### FIELD OF THE INVENTION

This invention relates to oxidizing catalysts, a carbon monoxide sensor, and a hydrogen sensor using the catalyst respectively, and more specifically to a catalyst selectively oxidizing carbon monoxide, a catalyst selectively oxidizing hydrogen, an carbon monoxide sensor not having the sensitivity to hydrogen existing together with the carbon monoxide, a hydrogen sensor not having the sensitivity to carbon monoxide existing together with the hydrogen, and a hydrogen purification catalyst for a fuel cell.

### CONVENTIONAL TECHNOLOGY

Carbon monoxide (CO) and hydrogen (H₂) coexist in exhaust gases generated when a coal gas, an water gas, a city gas, an LPG and other types of gases are incompletely combusted. As the carbon monoxide contained in the exhaust gases as described above is highly toxic, the following practice is applied for inspection of gas incomplete combustion alarm units in Japan.

In the practice for inspection of a city gas incomplete combustion alarm unit, it is required that the alarm unit can correctly give an alarm when carbon monoxide is present at 200 ppm, and also that the alarm unit should not give a false alarm when hydrogen is present at 500 ppm and ethyl alcohol at 1,000 ppm. In the practice for inspection of a high pressure gas incomplete combustion gas alarm unit, it is required that the alarm unit can give a first alarm when carbon monoxide is present at 250 ppm and hydrogen at 125 ppm and also can give a second alarm when carbon monoxide is present at 550 ppm and hydrogen at 275 ppm, and further that the alarm should not give a false alarm when ethyl alcohol is present at 1,000 ppm.

However, the prior sensors can not cause an alarm unit to give an alarm by selectively sensing carbon monoxide or hydrogen existing at the low concentration. A tin (II) oxide (SnO₂) semiconductor sensor is excellent in its sensitivity at the low concentration, but the sensor can not sense any gas selectively at all, and even if the sensor is temporally corrected with an activated carbon filter or the like, its repeatability is lost due to degradation of the activated carbon, and the sensor becomes unavailable. The contact combustion sensor detects temperature increase caused when a combustible gas reacts with a catalyst and burns on a heated coil as a change in the electric resistance, and there is not carbon monoxide sensor not having the sensitivity to hydrogen even among those in which the sensitivity to a gas (output) is proportional to the gas concentration.

It has generally been recognized that the hopcalite catalyst comprising MnO₂ by 70% and CuO₃ by 30%, or MnO₂ by 50%, CuO by 30%, CO₂O₃ by 15% and Ag₂O by 5% is promising as a catalyst capable of selectively oxidizing and detecting carbon monoxide in a gas mixture comprising carbon monoxide and hydrogen. As a carbon monoxide sensor, however, it has low selectivity to the gas with poor sensitivity, and further the catalyst is easily affected by poisoning and humidity and the performance substantially changes as time passes, so that the catalyst can not actually be used for any industrial purposes.

In the fixed high molecular type of fuel cell used in a fuel cell car now under development as an environment-compatible car, hydrogen is used as the fuel. As a method for production of hydrogen as the fuel, the hydrogen absorbing alloys method, catalytic decomposition of gasoline, methyl alcohol catalytic decomposition method, or other methods have been used. Of these methods, the hydrogen absorbing alloys method has the defect that the alloy used in the method being a rare earth alloy such as La—Ni₅ is expensive and heavy, and that the alloy is depleted. Although high purity hydrogen can be obtained by this method, the price of the hydrogen fuel is expensive. In the catalytic decomposition of gasoline, as the ratio of carbon atoms to hydrogen atoms contained in gasoline is higher in comparison to that in methanol, the method has the defect that a large quantity of hydrogen can not be produced. What is most expected among the methods listed above is the method of catalytically decomposing methanol allowing easy treatment of reactants in which methanol can be decomposed with a catalyst at a low temperature. Unless carbon monoxide contained in the hydrogen gas obtained through catalytic decomposition of methanol is removed, electrodes of the fuel cell are chemically degraded with the life becoming shorter, and there has been the defect in the prior art that carbon monoxide can not efficiently be removed from a gas mixture comprising carbon monoxide and hydrogen.

### SUMMARY OF THE INVENTION

It is an object of the present invention to provide a catalyst capable of selectively oxidizing carbon monoxide in a gas mixture comprising carbon monoxide and hydrogen as well as a catalyst capable of selectively oxidizing hydrogen in the gas mixture. It is another object of the present invention to provide contact combustion carbon monoxide sensor not having the sensitivity to hydrogen as well as a contact combustion hydrogen sensor not having the sensitivity to carbon monoxide.

The present invention provides a catalyst obtained by dispersing platinum black over a surface of a base metal compound oxide containing Co₂O₃, MnO₂₁ CuO, and Cr₂O₃ to form an Ag₂O layer on the platinum black layer and characterized in that the catalyst is capable of selectively oxidizing carbon monoxide in a gas mixture comprising carbon monoxide and hydrogen. In addition, the present invention provides a catalyst obtained by dispersing Ag₂O over a surface of the base metal compound oxide to form a platinum black layer on the Ag₂O layer and characterized in that the catalyst is capable of selecting oxidizing hydrogen in a gas mixture comprising carbon monoxide and hydrogen. Further the present invention provides a contact combustion carbon monoxide sensor using the catalyst selectively oxidizing carbon monoxide in its active section as well as a contact combustion hydrogen sensor using the catalyst selectively oxidizing hydrogen in the active section.

### DETAILED DESCRIPTION OF THE INVENTION

In this invention, a base metal compound oxide containing Co₂O₃, MnO₂, Cuo, and Cr₂O₃ each generating a small heat of oxide formation (−ΔHo) functions as a source to AG₂O, and activates the Ag catalyst. There is no specific limitation over composition of the base metal, but it is preferable that the content of MnO₂ is in the range from 44 to 55 weight %, 2CuO—Cr₂O₃ in the range from 25 to 40 weight %, and Co₂0₃ in the range from 15 to 20 weight %.

A catalyst capable of selectively oxidizing carbon monoxide in a gas mixture comprising carbon monoxide and hydrogen was obtained by dispersing platinum black particles over a surface of the base metal compound oxide to form an Ag₂O layer on the surface. Also a catalyst capable of selectively oxidizing hydrogen in the gas mixture above was obtained by dispersing Ag₂O over a surface of the base metal compound oxide to form a platinum black layer on the surface. These catalysts could repeatedly be used, and were stable in use for a long time.

The catalyst produced by homogeneously milling the base metal compound oxide, molding, activation, and then dispersing platinum black particles on a surface and forming an Ag₂O layer on platinum black is capable of selectively oxidizing carbon monoxide in a gas mixture comprising carbon monoxide and hydrogen. The catalyst is more stable as compared to the hopcalite. When the catalyst selectively oxidizing only carbon monoxide is used as a fuel cell, the catalyst oxidizes only carbon monoxide contained in the hydrogen gas of the fuel obtained by decomposing methanol with a catalyst such as ZnO—Cr₂O₃ or the like to carbon dioxide, and the resultant gas mixture does not give any damage to electrodes of the fixed high molecular type of fuel cell used for vehicles with a long life of the fuel cell insured.

The catalyst selectively oxidizing carbon monoxide according to the present invention is used in an active section of a carbon monoxide sensor based on the contact combustion system to form a sensor which can selectively detect carbon monoxide. A catalyst was obtained by dispersing platinum black particles on a surface formed by electrodepositing an electrodeposition coating containing the base metal compound oxide by 60 to 70 weight % and γ-Al₂O₃ by 30 to 40 weight % on a Pt line coil or an Fe—Pd line coil and calcinating the electrodeposited coating to form an Ag₂O layer thereon. The contact combustion carbon monoxide sensor having a bridge circuit in which a coil having this catalyst is used in the active section is a contact combustion carbon monoxide sensor providing output for carbon monoxide in the range from 20 to 22 mV when the carbon monoxide concentration is at 500 ppm or output for hydrogen in the range from 0 to 1 mV when the hydrogen concentration is at 500 ppm. This carbon monoxide sensor is that not having the sensitivity to hydrogen even when carbon monoxide and hydrogen coexist. The carbon monoxide sensor having the sensitivity only to carbon monoxide can be used in applications such as city gas incomplete combustion alarm units, alarm units based on practices in foreign countries, and other security-related devices.

The hydrogen sensor according to the present invention is a contact combustion hydrogen sensor having a bridge circuit in which a coil having a catalyst formed by dispersing Ag₂O over a surface formed by electrically depositing an electrodeposition coating comprising the base metal compound oxide by 60 to 70 weight % and γ-Al₂O₃ by 30 to 40 weight % on a Pt or Fe—Pd line coil and then calcinating the compound oxide is used, and have the sensitivity (output) of 0 to 1 mV for carbon monoxide at the concentration of 500 ppm and also of 35 to 40 mV for hydrogen at the concentration of 500 ppm. This hydrogen sensor does not show its sensitivity to carbon monoxide even when carbon monoxide and hydrogen coexist. This hydrogen sensor can detect hydrogen generated when the transoil is degraded.

With the catalyst selectively oxidizing carbon monoxide and that selectively oxidizing hydrogen each according to the present invention, it is possible to selectively detect and oxidize carbon monoxide or hydrogen at the low concentration, and the catalysts are extremely useful for providing a carbon monoxide sensor not having the sensitivity to hydrogen which has been a defect of carbon monoxide sensors based on the conventional technology as well as for reforming hydrogen for a fuel cell.

The present invention is described in detail below with reference to the embodiments. The embodiments are described below only for the illustrative purpose, and are not intended to limit the present invention in any means.

### EXAMPLE 1

| | |
|---|---|
| MnO₂ | 52 weight % |
| 2CuO—Cr₂O₃ | 32 weight % |
| Co₂O₃ | 16 weight % |

A mixture of the compounds above was mixed and pulverized with a ball mill and was then molded into a cylindrical body with the diameter of 3.0 mm and length of 3 mm, which was calcinated under the temperature of 500° C. to activate the mixture as an oxide catalyst. After the surface was fully cleaned, the [Pt(NH₃)₄](NO₃)₂(1:60) solution was applied to the surface by dipping or blowing, the surface was dried and subjected to thermal decomposition to obtain platinum black, and then the AgNO₃ 0.7 g/L solution was applied to the surface by spraying or the like, which was dried, subjected to thermal decomposition, washed with water, and dried to obtain a catalyst. 20 L of mixed gas comprising carbon monoxide at the 500 ppm and hydrogen at 500 ppm was passed through a vessel filled with this catalyst and having the diameter of 1 cm and length of 31 cm at the flow rate of 22.5 L/min, and no carbon monoxide was detected from the exhausted gas, and a gas mixture comprising carbon dioxide at the concentration of 500 ppm and hydrogen at the concentration of 500 ppm was obtained.

### EXAMPLE 2

| | |
|---|---|
| MnO₂ | 30 weight % |
| 2CuO—Cr₂O₃ | 18 weight % |
| Co₂O₃ | 9 weight % |
| γ-Al₂O₃ | 43 weight % |

An electrodeposition coating containing the base metal oxide and γ-Al₂O₃ as described above was electrically deposited on a coil formed by coiling an Fe—Pd line with the diameter of 30 μm and having 22 turns each with the inner diameter in the range from 0.8 to 1.0 mm. The compound oxide was formed at the rate of about 0.02 g per coil. After died under a low temperature, the coil was dried for two hours under the temperature of 120° C., and then was calcinated for 15 to 20 minutes under the temperature of 500° C. to obtain a compound oxide. About 0.1 cc of the [Pt(NH₃)₄](NO₃)₂(1:60) solution was applied to a surface of the compound oxide, which was dried and decomposed under the temperature of 500° C. to give platinum black. The surface was cleaned and dried, and then about 0.1 cc of the AgNO₃ 0.7 g/L solution was applied to the platinum black with the surface dried, subjected to thermal decomposition, and washed, and the coil having the resultant catalyst was used in an active section of a bridge circuit of the contact combustion carbon monoxide sensor. When this sensor was used as a 6V sensor based on the contact combustion system under the conditions of sensor temperature in the range from 150 to 160° C. and bridge voltage of 6V for D.C 25 mA, the sensor provided the output of 20 to 22 mV for carbon monoxide at the concentration of 500 ppm, but it provided only the output of 0 to 2 mV for hydrogen at the concentration of 500 ppm.

### EXAMPLE 3

| | |
|---|---|
| MnO₂ | 29 weight % |
| CuO | 17 weight % |
| Co₂O₃ | 11 weight % |
| γ-Al₂O₃ | 43 weight % |

The electrodeposition coating containing the base metal oxide and γ-Al₂O₃ as described above was adjusted and was electrically deposited on a Fe—Pd 30 μm line coil. More specifically, the coating was electrically deposited on a coil formed by coiling the Fe—Pd line with the diameter of 30 μm with 22 turns each having the inner diameter in the range from 0.8 to 1.0 mm so that a quantity of the compound oxide was about 0.02 g for each coil. After dried under a low temperature, further the coil was dried for two hours under the temperature of 120° C. and calcinated for 15 to 20 minutes under the temperature of 500° C. to obtain an compound oxide. After about 0.1 cc of the AgNO₃ 0.7 g/L was applied to a surface of the compound oxide and was dried, the [Pt(NH₃)₄](NO₃)₂(1:60) solution was adjusted, and about 0.1 cc of the solution was applied to a surface of the compound oxide, the surface was died and subjected to decomposition under the temperature of 500° C. to form platinum black, and a coil having the resultant catalyst was used in an active section of a bridge circuit of a hydrogen sensor based on the contact combustion system. When this sensor was used as a 6 V sensor based on the contact combustion system under the conditions of sensor temperature in the range from 150 to 160° C., D.C voltage of 6 V and 25 mA, the sensor provided the output of about 0 mV for carbon monoxide at the concentration of 500 ppm, and also provided the output of 35 to 40 mV for hydrogen at the concentration of 500 ppm. When only the active section was subjected to the aging test by applying the voltage of 3.5 V for 99 days thereto, the average value of the sensitivity to hydrogen (output) at the concentration of 500 ppm was 32.5 mV, and that to carbon monoxide at the concentration of 500 ppm was 0.1 mV.

1. A catalyst obtained by dispersing platinum black over a surface of a base metal compound oxide containing Co₂O₃, MnO₂, CuO, and Cr₂O₃ to form an Ag₂O layer on said platinum black layer, wherein said catalyst selectively oxidizes carbon monoxide in a gas mixture comprising carbon monoxide and hydrogen.

2. A contact combustion carbon monoxide sensor having a bridge circuit with an active section, wherein said carbon monoxide sensor has the catalyst according to claim 1 formed by dispersing platinum black on a surface of the coil with a base metal compound oxide containing Co₂O₃, MnO₂, CuO and Cr₂O₃, further with γ-Al₂O₃ mixed therein electrically deposited on the coil to form an Ag₂O layer on the platinum black layer in the active section formed with a Pt line coil or an Fe—Pd line coil.

3. The catalyst according to claim 1, wherein said gas mixture comprising carbon monoxide and hydrogen is a hydrogen gas which is a fuel for a fuel cell.

4. A catalyst obtained by dispersing Ag₂O on a surface of a base metal compound oxide containing Co₂O₃, MnO₂, CuO, and Cr₂O₃ to form a platinum black layer on said Ag₂O layer, wherein said catalyst selectively oxidizes hydrogen in a gas mixture comprising carbon monoxide and hydrogen.

5. A contact combustion hydrogen sensor having a bridge circuit with an active section provided therein, wherein said contact combustion hydrogen sensor has the catalyst according to claim 4 formed by dispersing Ag₂O on a surface of a coil with a base metal compound oxide containing Co₂O₃, MnO₂, CuO and Cr₂O₃ further with γ-Al₂O₃ mixed therein electrically deposited thereon to form a platinum black layer on said Ag2O layer in the active section formed with a Pt line coil or an Fe—Pd line coil.
